(19) United States
(12) Patent Application Publication
(10) Pub. No.: US 2016/0094536 A1
(43) Pub. Date: Mar. 31, 2016

(54) SYSTEM AND METHOD FOR PORTABLE SOCIAL DATA IN A WEBPUBLISHING APPLICATION

(71) Applicant: Frederick R. Krueger, Santa Monica, CA (US)

(72) Inventor: Frederick R. Krueger, Santa Monica, CA (US)

(21) Appl. No.: 14/871,582

(22) Filed: Sep. 30, 2015

Related U.S. Application Data
(60) Provisional application No. 62/057,852, filed on Sep. 30, 2014.

(51) Int. Cl. H04L 29/06

(52) U.S. Cl. CPC H04L 63/083; H04L 63/102

(57) ABSTRACT

A system and method is described for managing permissions for a system that organizes shared electronic media using a card/deck/project schema. A permissions manager allows a user to share a card, deck or project with another user and further provides the option of requiring the receiving user to log in to access the shared media using the receiving user's system password. Advantageously, the receiving user does not need to remember another password, but merely enters his/her system user ID and system password to access the shared media. The sharing user can turn off all permissions to a single user with a single action.

### CROSS REFERENCE TO RELATED APPLICATIONS

This patent application claims the benefit of and priority to U.S. Provisional Patent Application Ser. No. 62/057,852, filed on Sep. 30, 2014, titled “System And Method For Portable Social Data In A Web Publishing Application,” the disclosure of which is hereby incorporated by reference for all purposes.

### BACKGROUND INFORMATION

### Technical Field

The present invention relates to user authentication for web applications.

### SUMMARY OF THE DISCLOSURE

The present disclosure relates to a security system for the secure sharing of a system of private websites, and more specifically, to a method for the secure sharing of a system of private websites.

### BRIEF DESCRIPTION OF THE DRAWINGS

FIG. 1 shows an example card input interface according to one embodiment.

FIG. 2 shows two card decks forming a project according to one embodiment.

FIG. 3 shows a project formed of two card decks run through a reader application to display the project on a mobile computing device and a large screen display.

FIG. 4 shows a project hosted on cloud storage simultaneously accessible by various computing devices.

FIGS. 5A and 5B show example Create Account and Login screens for an application according to one embodiment.

FIG. 6. shows an example User Profile Preferences screen for an application according to one embodiment.

FIG. 7 shows an example Project screen for an application according to one embodiment.

FIGS. 8A and 8B show example New Project screens for an application according to one embodiment.

FIG. 9 shows an example Template Preview screen for an application according to v.

FIGS. 10A and 10B show example URL Selection screens for an application according to one embodiment.

FIG. 11 shows an example Project Settings screen for an application according to one embodiment.

FIG. 12 shows an example Share Settings screen for an application according to one embodiment.

FIG. 13 shows an example Add First Card screen for an application according to one embodiment.

FIG. 14 shows an example Add New Card screen for an application according to one embodiment.

FIG. 15 shows an example Standard Card screen for an application according to one embodiment.

FIG. 16 shows an example Link/Video Card screen for an application according to one embodiment.

FIG. 17 show example completed cards for an application according to one embodiment.

FIG. 18 shows an example Grid View for an application according to one embodiment.

FIG. 19 shows an example List View for an application according to one embodiment.

FIG. 20 shows an example Card View for an application according to one embodiment.

FIG. 21 shows an example Share screen for an application according to one embodiment.

FIG. 22 shows an example Share screen with log-in permissions management according to one embodiment.

FIG. 23 shows an example Site-Wide Sharing Permission management screen according to one embodiment.

FIG. 24 shows an example Project Contacts screen for an application according to one embodiment.

FIG. 25 shows an example Contact Invitation screen for an application according to one embodiment.

FIG. 26 shows an example Contact Profile screen for an application according to one embodiment.

FIG. 27 illustrates an exemplary networking environment, wherein the novel aspects of the claimed subject matter can be employed.

FIG. 28 illustrates an exemplary operating environment that can be employed in accordance with the claimed subject matter.

### DETAILED DESCRIPTION

What is described here, and will be immediately useful to anyone skilled in the art, is a multi-website social media sharing system with a permissions system that provides for simple and easy management of sharing permissions and simple access to shared media.

The multi-website social media sharing system is a universal and portable way of breaking all these different kinds of data into autonomous editable atomic elements called “cards,” that can be either stored on the user's computer or in the cloud, do not require a proprietary database, and can be easily arranged, added to or subtracted from and allow for a wide array of uses.

In particular, this system allows cards of data to be easily and efficiently stored on a mobile device such as a smart phone or tablet so that all the data is only downloaded once and that viewing or modifying a project of hundreds or even thousands of cards can be done in real time, or without a network connection at all.

One of the major advantages of the system and method described herein is that these cards can incorporate social data in the form of conversations—a set of comments either threaded or unthreaded from the users who have access to view and modify in some way a given card, which, in the preferred embodiment is set at the project level. Thus, a card encapsulates user comments so that the comments are transportable with the card across projects.

With this system users can organize their private diaries, photographs, travelogues, websites, recipes, personal data, events and so on into discrete chunks of data, each of which encapsulates social conversations on that specific item of data and nothing else.

The present invention provides a system and method for organizing sharing and publishing data in discrete units, called cards, which encapsulate text, image, video, custom fields and date fields as well as comments within a social network of users. Each card can be cached on a mobile device, such as a phone or tablet, to be used in an offline mode, or quickly accessed while online without downloading a large HTML file or accessing the same image or video file repeatedly. A group of cards, or card deck, forms a homogeneous set of data. Multiple card decks form a project with defined user access permissions for viewing, creating or editing cards. Projects may be represented as icons similar to apps on a mobile phone, and can be stored in folders. The “project apps” and folders apps can be re-arranged or deleted using user interface conventions similar to those used to ordinary mobile phone apps. This system and method provides a useful framework for organizing data in a wide variety of applications, including web site building tools, project management, blogging, photo galleries, e-commerce and general business networking applications for small groups.

There have been previous general purpose attempts at concentrating content into atomic content which on the surface might resemble the present invention. There are, however, two very fundamental differences between these systems and the present invention.

In the present invention, each card consists entirely of re-usable data—data which is not bound to a specific presentation of the data. For example, every single card in a project or deck will have a title, a description and a date field, but no specific location, color, font or other formatting of that data. In other words, each card can contain bibliographic and content data, but does not contain format data. This means that the entire project can be shown in dramatically different ways. This is a very fundamental difference—and is also a difference with static web authoring tools such as Weebly, or Squarespace where that same formatting happens at the page level—ie: you need to go into every individual page to edit the data of the page.

Furthermore, each card can contain comments/discussion from other users. In other words it is not just the user's data—it is social data. The abstraction of social data into the card itself, and not trapped in a specific social application such as Facebook or Basecamp is both novel and fundamental to the invention.

Furthermore, each card, deck and project are individually and immediately shareable with other users. That is, a card or deck does not need to be saved separately from the project before being shared. Individual cards and decks can be shared by any number of ways without departing from the scope of the invention. For example, a card can be shared by selecting and holding the card, then selecting “share” from the pop-up menu that appears. A card can then be shared with selected individuals. Likewise, a deck or project can be thus shared. In an example embodiment, when the user activates the share menu from a card, the share menu offers the choices of sharing the card, the deck or the project.

Sharing of and access to a card, deck or project is controlled through a permissions manager. The permissions manager allows a user to share a card, deck or project with another user by simply toggling or otherwise turning on the permission for that user. The permissions manager further provides for the option of requiring the receiving user to log in to access the shared media. The system does not require the sharing user to create a password; rather, the system uses the receiving user's system password. Advantageously, the receiving user does not need to remember another password, but merely enters his/her system user ID and system password to access the shared media.

Structures

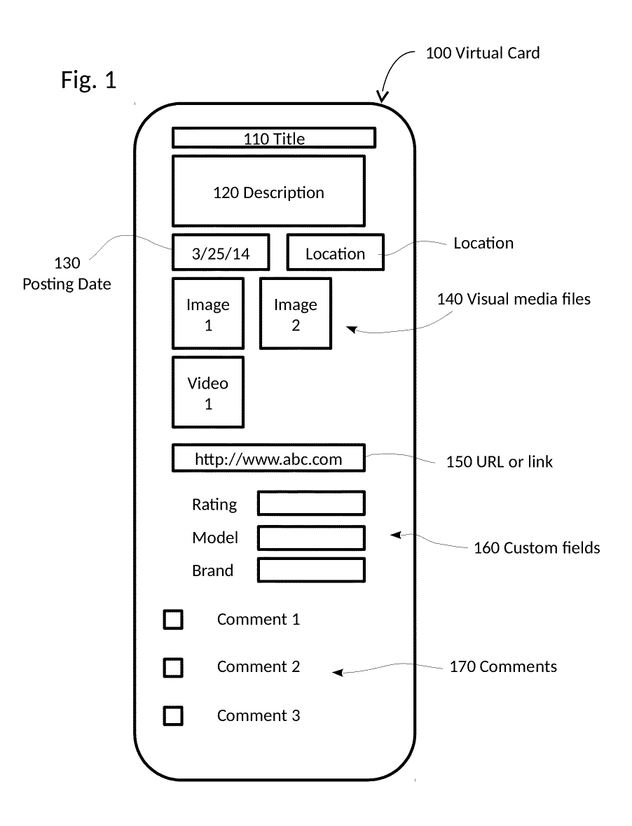

Card—A project page is represented by a card, as shown and generally described as 100 in FIG. 1. A card 100 includes a title 110, a description 120, and a posting date 130. One or more cards make up a deck. Decks can be of different card deck types, such that the content data is displayed according to a predetermined format. For example, a deck can be for services, team, news, and the like. The card also preferably provides for attaching visual and/or audio media files 140, a url or link 150 to another card that the user has permission to repost or a webpage external to the project, custom fields 160 and comments 170.

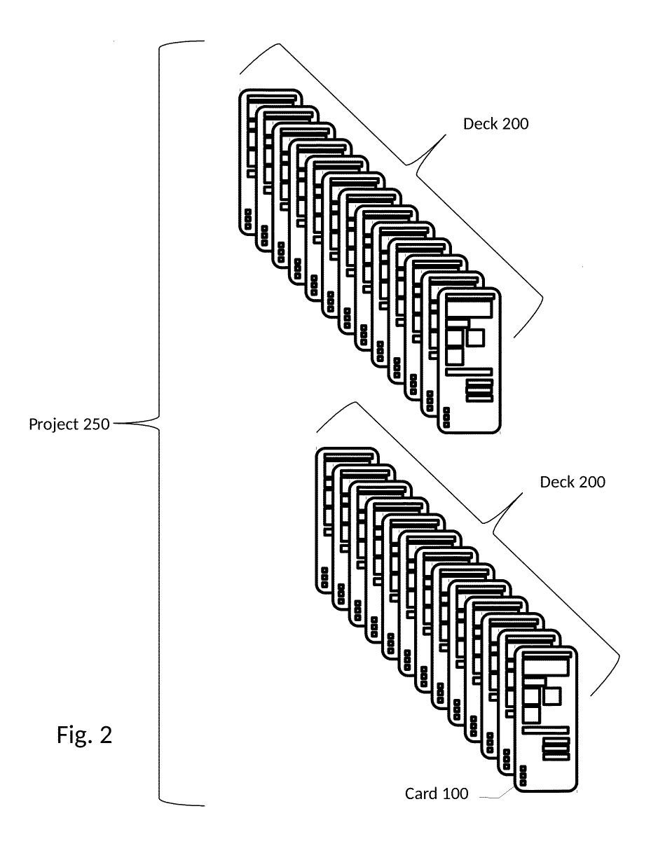

Deck—As shown in FIG. 2, a deck 200 can be formed of one or more cards 100. A single card can constitute a deck.

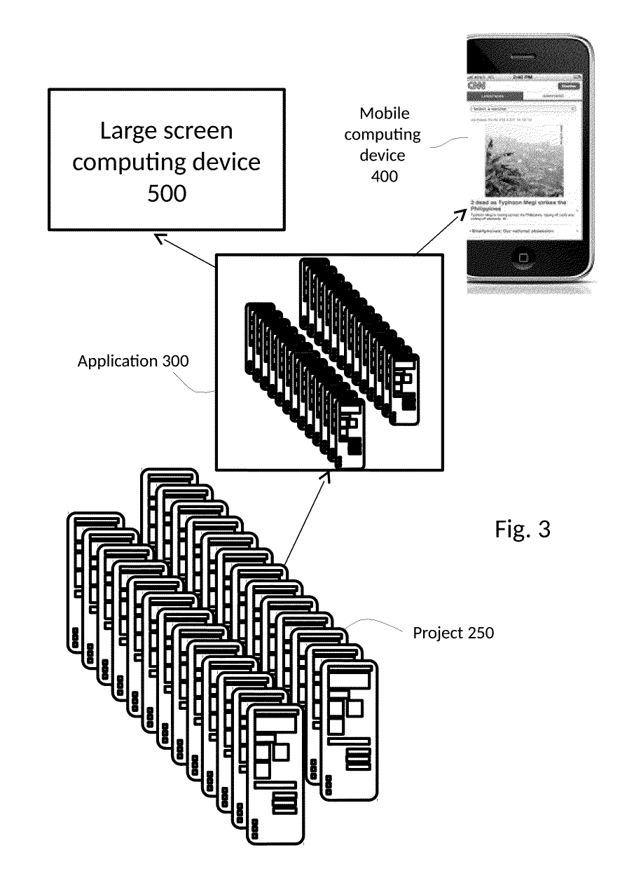

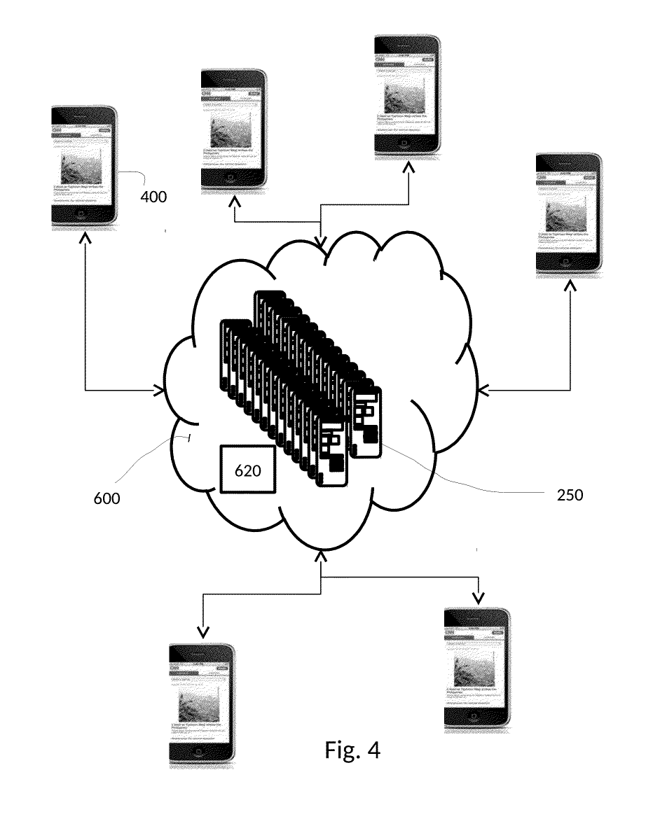

Project—One or more decks form a project 250. As shown in FIG. 3, a project 250 can be read by an application 300 to display on a computing device. The computing device may be a mobile computing device 400 or any other type of computing device, such as a computing device with a large screen display 500. In the case of a large-screen display 500, the application uses a template associated with the project to display the project as a website. Cards, decks and projects may be stored separately in a central cloud server 600 (FIG. 4) and simultaneously accessible by multiple devices 400.

The central cloud server 600 includes a permission manager 620 for managing the sharing permissions. The permissions manager may require a receiving user to log in to shared media using their username and system password.

Application—A software application, also known as project manager, reads the project cards, displays them, and allows the user to manage the project. Multiple projects can be accessed through the application and the application can run several projects simultaneously.

Features

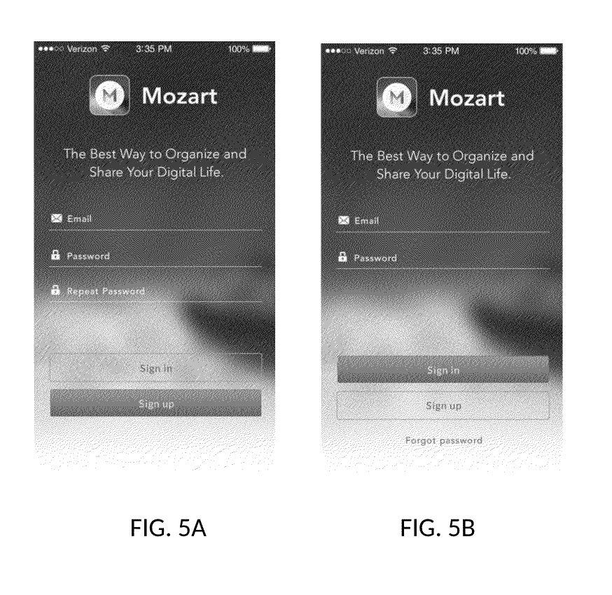

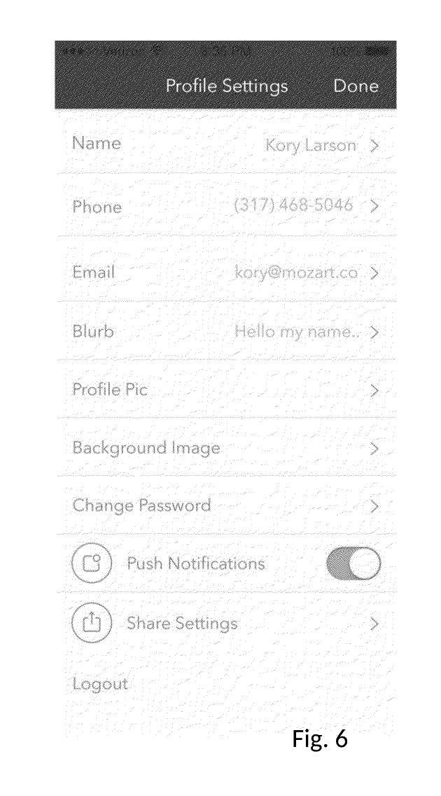

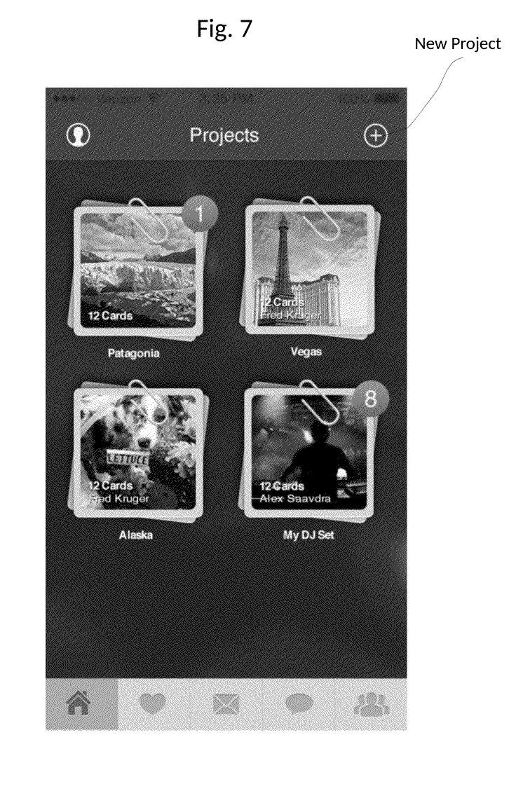

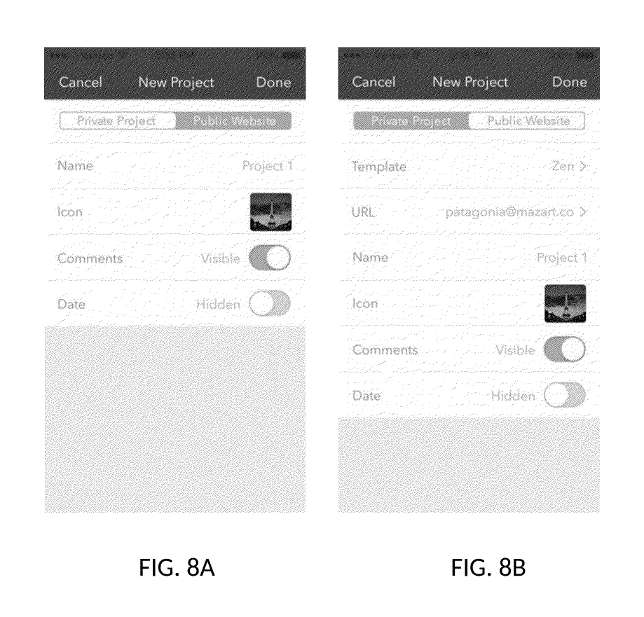

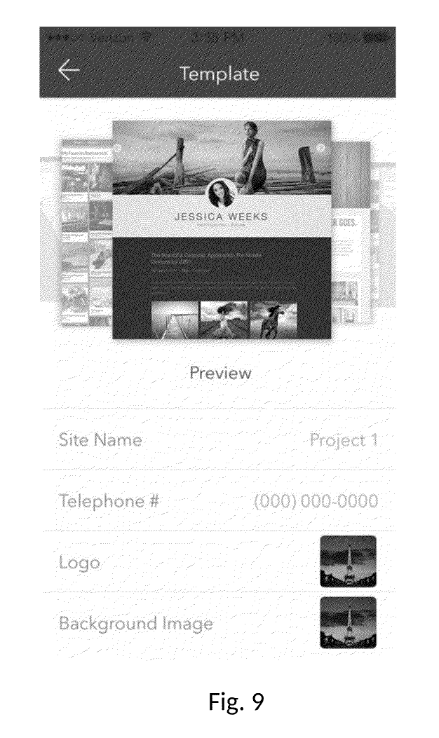

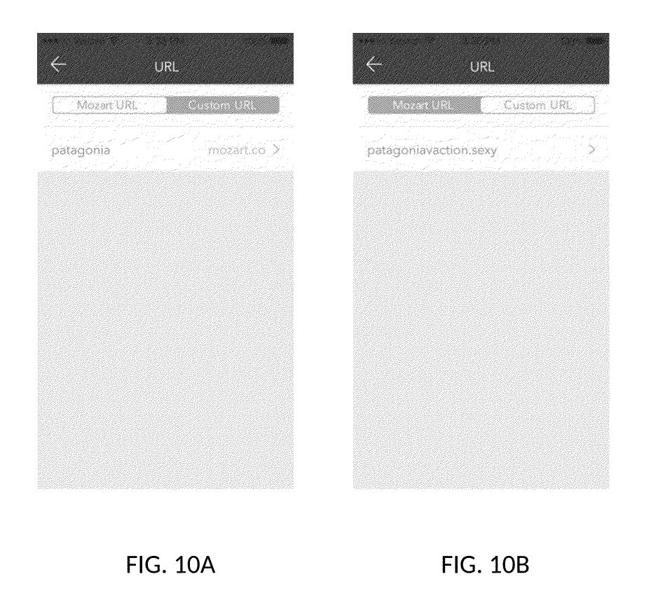

To use the present invention, a user launches the application and creates an account (FIG. 5A) and logs in (FIG. 5B). The user next creates a user profile with name, phone, email, a description (blurb), a profile picture, background image and the like and also sets global preferences, such as share settings, notification settings and the like (FIG. 6). The user then creates at least one project from the projects screen (FIG. 7) by selecting the New Project button. The new project screen appear (FIG. 8A) where the user selects whether the project is public or private, inputting the project name, selecting a project icon, and selecting whether comments, date and the like are visible. For public projects (FIG. 8B) that will be viewed as websites, the user additionally initiates selection of the website template and URL from this screen. For example, when the template button is held, a dropdown menu of available templates appears. When a template is selected, the user can then select the preview button to retrieve the template preview screen (FIG. 9). This screen shows a preview of the website template and also is where the website name, telephone number, logo, background image and similar information can be entered. For the URL, the user either selects the URL entry field and types in the URL, or selects to move to the URL entry fields. FIG. 10A shows a URL entry screen with a standard URL provided by the application. In the example, the URL is patagonia.mozart.co. FIG. 10B shows a custom URL, wherein the user provided the URL: patagoniavacation.sexy.

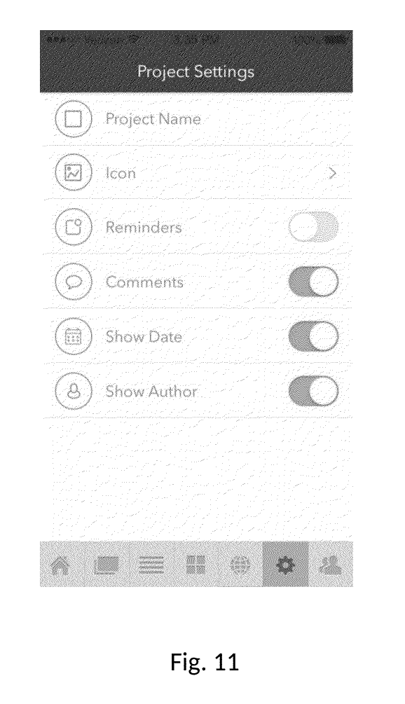

Projects can also be received through sharing. When a new shared project is receive, the user is notified through the projects screen. Additionally or alternatively, a “new shared project” icon can appear in the top menu or elsewhere to notify the reader. Once a project is created, the project settings can be changed on the Project Settings screen (FIG. 11).

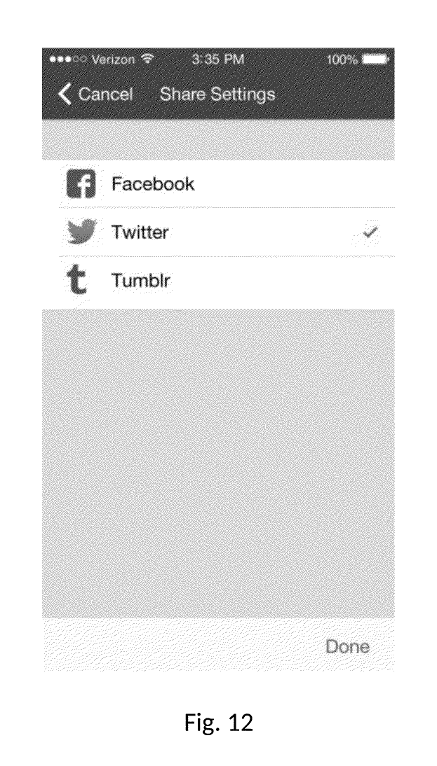

The user may set social media share settings for the project from the Share Settings screen (FIG. 12). These share settings are for projects that are to be shared publicly or privately.

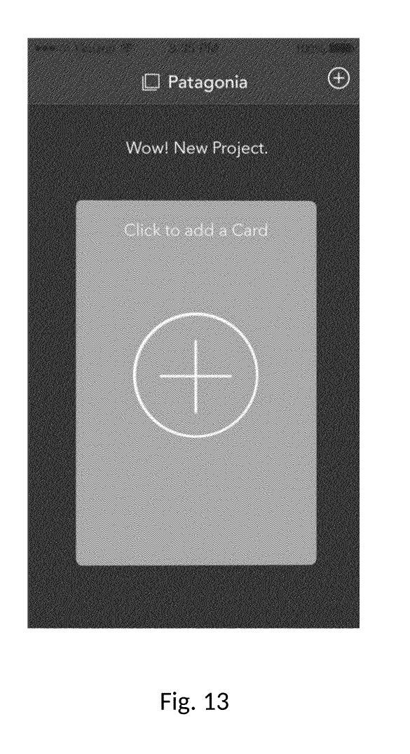

Once the user has completed the setup, a screen to add a first card appears (FIG. 13).

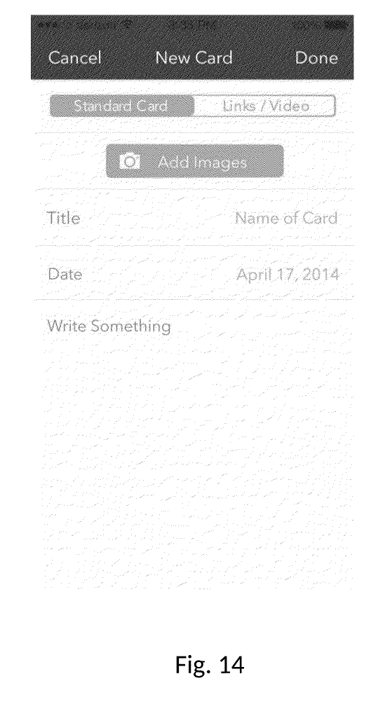

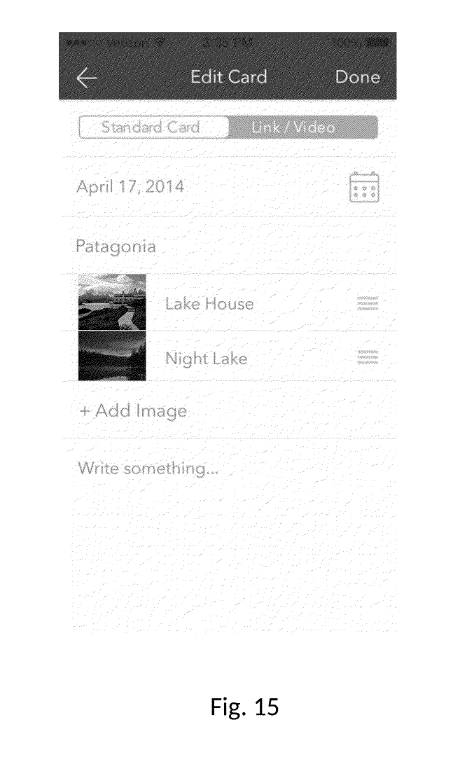

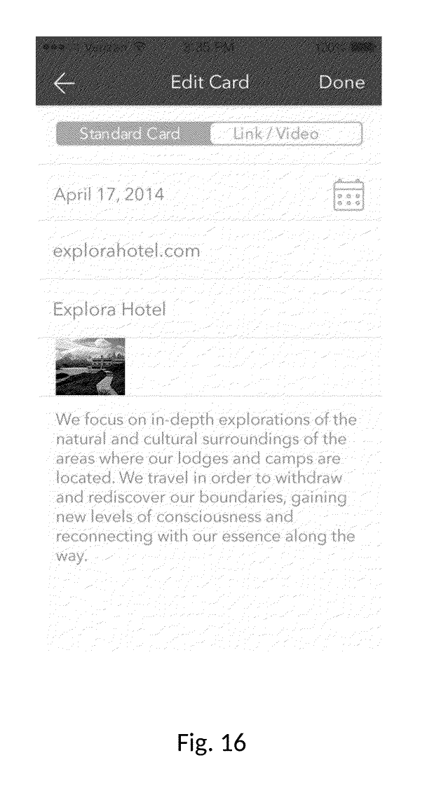

At any point the user can select to create a new card and default settings will be used for those settings not chosen. The user can return to the project page and add a card to the project, through the New Card screen (FIG. 14). There are at least two types of cards: standard cards and link/video cards. The user inputs the desired information, such as title, description and date for the card. Images can also be added to a card. An example standard card is shown in FIG. 15. A user can also choose to create a link/video card, as shown in FIG. 16. In these cards the user chooses links or video to be incorporated into the card.

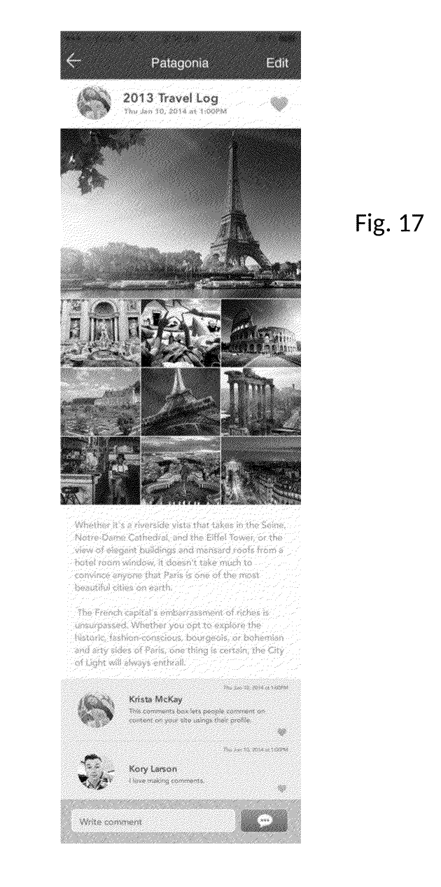

Example completed cards are shown in FIG. 17.

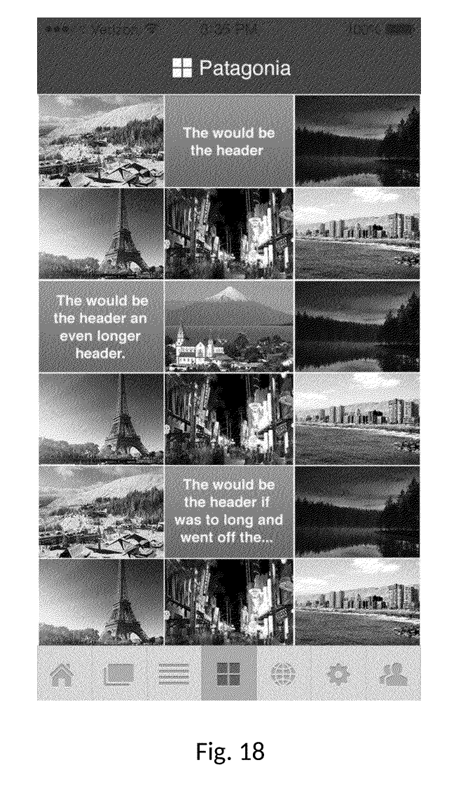

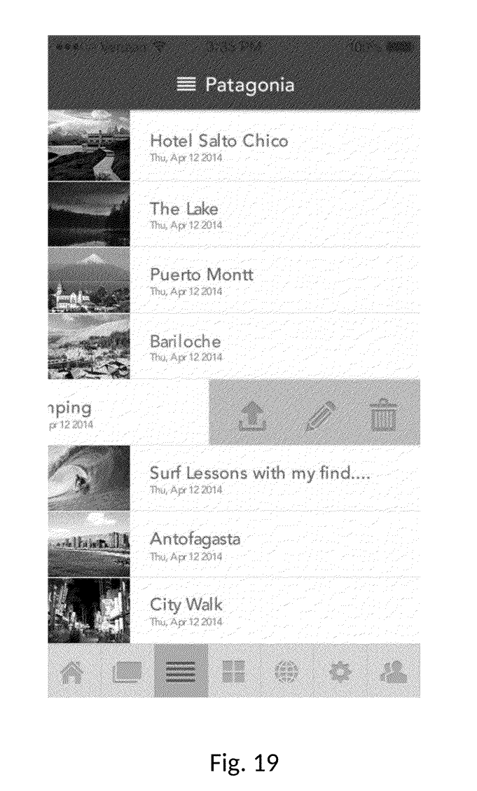

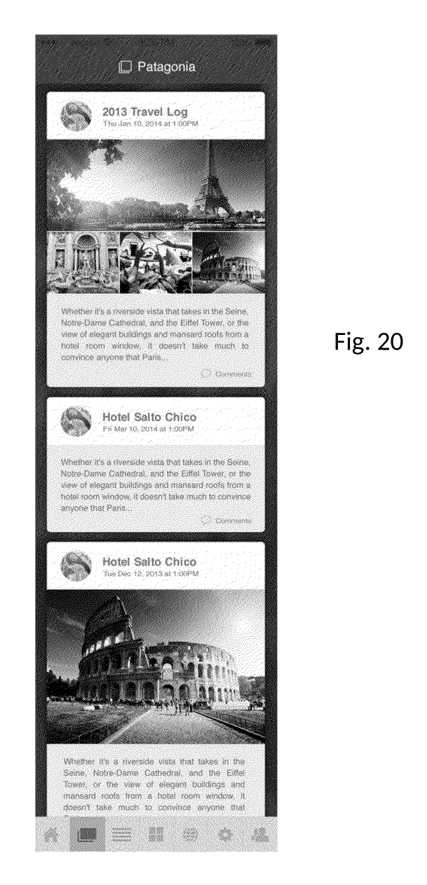

Cards can be displayed in a grid view (FIG. 18), which shows the multimedia data associated with each page, in a list view (FIG. 19), which gives a list of the cards in each project, or in a card view (FIG. 20), which shows full cards and allows the user to scroll through the full cards.

As shown in FIG. 18, the GRID view provides for seeing multiple cards in a single view. A grid of rectangular cards is the most efficient way to display multiple cards on a limited display such as a cellular phone. In grid view, cards can be added, deleted, re-ordered and the like.

The LIST view provides for re-ordering the cards and deleting them (FIG. 19). In one embodiment, the cards in the list can be re-ordered by dragging them up and down using handles. A card can be deleted in many ways. For example, by swiping left on the card. As shown in FIG. 19, the EDIT LIST view may also provide buttons for performing sharing, editing and deleting a card.

In a preferred embodiment, selecting and holding a card causes an action menu to appear. The action menu provides selectable functions such as DELETE, COPY, SHARE and the like. Cards can be copied to other decks according to commonly-used methods. In a preferred embodiment, a card can be copied to another deck by selecting COPY from the pop-up menu, then opening the deck to which the card is to be pasted, selecting and holding the space between the cards where then new card is to go, thus cause the action menu to appear, and selecting “PASTE from the pop-up menu.

Additionally or alternatively, the action menu contains the command EXPORT or similar, which when selected removes the card from the deck and causes the list of projects to appear, whereupon the user then selects the desired deck. The desired deck opens, and the user then places the card to the desired position as previously described.

Additional or alternative methods for copying cards between decks can be used without departing from the scope of the invention.

Moving between cards can be done in any of the methods used to move between objects on a mobile device. For example, the user can swipe the card to move it in a particular direction. Additionally or alternatively, the user can touch the border of the card on the side in which he wants to the card to move.

Full-screen views of the images associated with a card are also provided for and the user can move between full screen images by swiping, tapping or other methods.

In a preferred embodiment, the user swipes or border-touches left or right to move between cards and top or bottom to move between images on a card with multiple images.

Projects can be divided into different projects or merged with other projects

Projects can be divided in different ways without departing from the scope of the invention. For example, a project can be divided by selecting a group of cards, holding down the cards to activate a pop-up menu, and selecting the export function from the menu.

Projects can be merged in different ways without departing from the scope of the invention. For example, projects can be merged by ordering the projects in the desired merge order, selecting the projects to be merged, holding down the selection to activate a pop-up menu, and selecting the merge function from the menu.

Projects, decks and cards can be shared with other users. Sharing can be private or public. If public, the project can be accessed through a domain name. Projects can be shared privately across a public network.

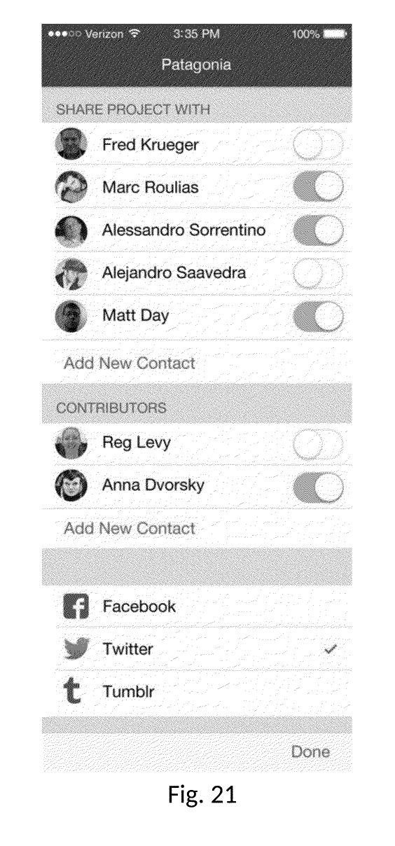

As shown in FIG. 21, in the case of privately-shared media, the user determines who to share the project with, who can contribute to the project, and which social media to share the project over.

Once a project is shared with another person, any changes or new cards are preferably automatically synchronized to the computing devices of the share-receiving users.

Any sharing method can be used. Preferably, a swipe-to-share method is used, as shown in FIG. 21. With this system, a user simply swipes the switch to share the entire project with another user. Thus, the user can easily share an entire project, not single files. A received project is saved automatically in a local cache.

Additionally, a user can be added as a viewer or editor by showing all recent people with which any project has been shared. The user then selects “viewer” or “editor” for a user, thus making sharing a one click operation.

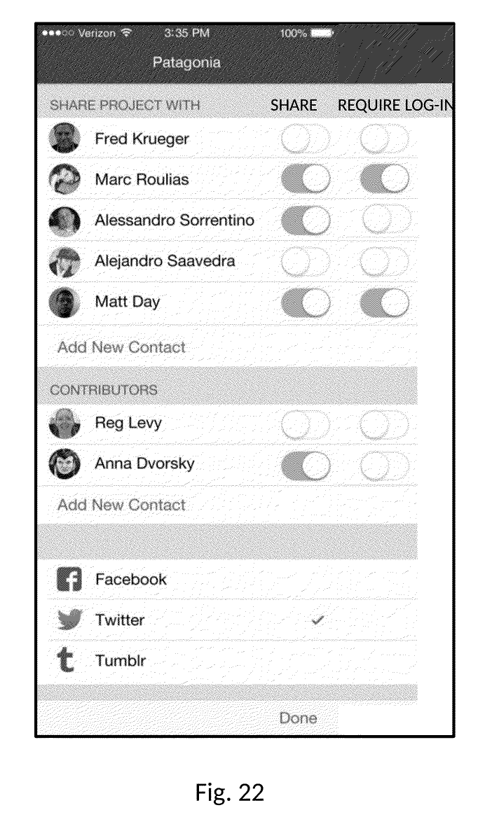

The system further allows the sharing user to specify whether the receiving user must enter his/her system username and password to access the shared project. Advantageously, the receiving user does not have to create or remember any new passwords. FIG. 22 shows the interface wherein this added security is specified. The added security of a password prevents someone other than the receiving user from using the receiving user's access device without knowing the receiving user's password. For example, if the receiving user loses his/her cell phone and a third party finds it, they could access the shared project if no password were required.

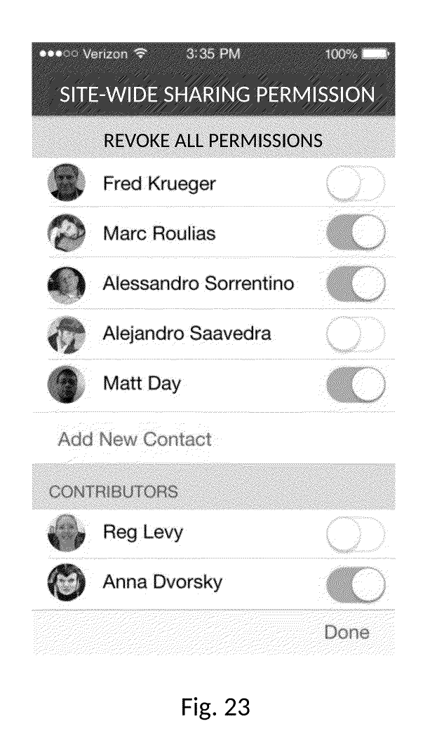

Furthermore, in the case of a security breach, the sharing user can turn off all permissions to a single user with a single action. FIG. 23 shows the Site-Wide Sharing Permission interface wherein the sharing user is presented with the option of revoking sharing permissions for a user.

The present system works better than creating a single password for a website for several reasons. First because whereas a user may share a third party password, the user is not likely to share a personal password such as his/her system password. Second, if there is a security breach or a security breach is suspected for a user, then only that user's permissions need to be revoked. In a system with a single password for all users, all users would need to be notified of a changed password.

In a preferred embodiment, the uniform resource locators (URLs) for the websites are semantic URLs, also sometimes referred to as clean URLs, RESTful URLs, user-friendly URLs, or SEO-friendly URLs. Semantic URLs are preferred because the concealment of internal server or application information can improve the security of a system.

Upon receipt of a project, a user can download the entire project as a single entity. This single-swipe and whole project sharing allows for faster browsing and can increase productivity.

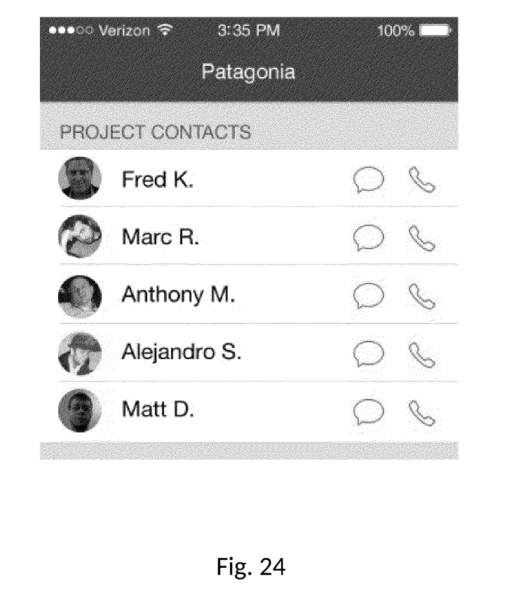

As shown in FIG. 24, the persons with whom the project has been shared can preferably be contacted directly from the application through the project contact screen.

Decks can be published automatically by associating both a domain name and a design template with the card. This can be done by selecting these in the card settings (FIG. 8B). The domain name is a unique URL that can be either free of charge (a third level domain, for example, such as fred.mozart.com), or a second level domain such as fred.com. The template can be selected from a set of available templates using a drop down menu, or by selecting it in a page of available templates. Once a project is published to a network website, edits and new cards are preferably automatically synchronized to the website.

Thus, the disclosed embodiment provides for a social media management system that is modular, portable and easy to use. As can be seen from the examples, the website code is readable and updatable by a person unskilled in computer languages.

Each project, once published, has a homepage that can be shifted between Grid, list and Full card view and allows the user to interact with projects, decks and cards according to their share settings.

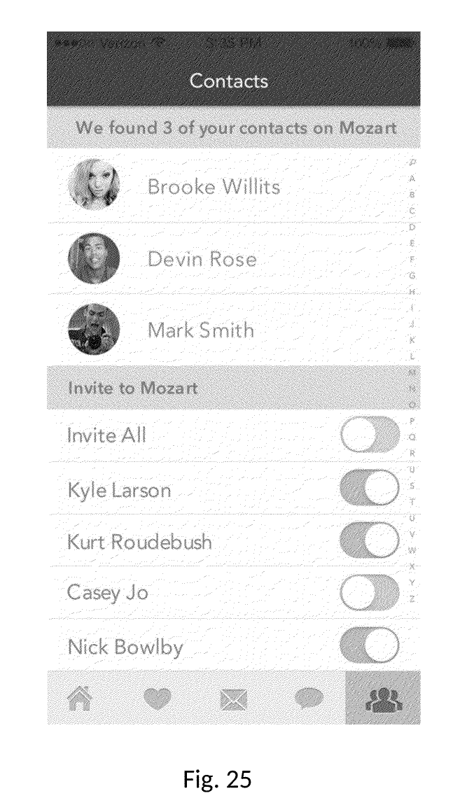

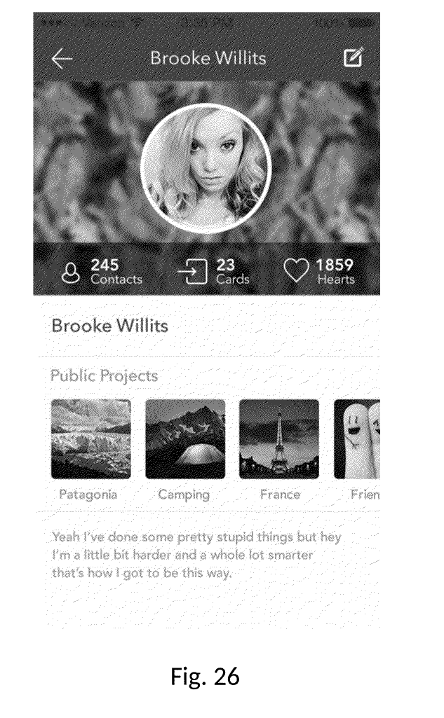

Contacts can be invited to the social network according to the present invention. FIG. 25 shows a contact invitation page. FIG. 26 shows a contact profile page, including the public applications.

Also, a messaging service is provided for transmitting messages between users.

Thus a system for sharing multimedia according to the present invention includes: a cloud storage server; a permissions server; at least one remote computing device; and a network; the servers and remote computing device in electronic communication through the network; the storage server storing at least one project, the project comprising at least one card deck, the card deck composed of at least one card; the at least one card containing text, hypertext and multimedia data; the remote computing device running a project manager operable to store, edit, display and share the at least one project, at least one card deck or at least one card data; the permission server running a permissions manager; the permissions manager able to perform the following functions: allow the at least one remote computing device to access the at least one project, at least one deck or at least one card; deny the at least one remote computing device access to the at least one project, at least one deck or at least one card on a site-wide basis; and require a log-in through the remote computing device using a site username and password; thereby providing a system of sharing multimedia that is easy to use.

The disclosed embodiments also provide a method for sharing multimedia, the steps including: providing a system as herein described; the system executing the following steps: storing text, hypertext and multimedia data as at least one card file; storing the at least one card file in a deck; receiving edits to the at least one card file; and the permissions server managing permissions to the at least one card file, to the deck, or to the project; wherein the step of managing permissions includes: allowing access to media to a receiving user, denying access to media to a receiving user on a site-wide basis with a single action, and requiring a receiving user to log in using the user's site username and site password; thereby providing a system of sharing multimedia that is easy to use. The system may also use semantic uniform resource locators to provide access to the project media.

The disclosed embodiments also provide a system for managing websites, the system including: a cloud storage server; a permissions server; at least one remote computing device; and a network; the servers and remote computing device in electronic communication through the network; access to the system requiring a system username and password; the storage server storing a multiplicity of projects, the projects each comprising at least one card deck, the card deck composed of at least one card; the at least one card containing text, hypertext, viewer comments and multimedia data; wherein each project has a corresponding website. The system organizing the multiplicity of projects into subsets, wherein a subset is the projects and/or project websites shared by a first user with a second user. For example, a first user decides to his travelogue projects and/or their corresponding webpages with a friend. These are a subset of projects and/or projects' websites. The second user accesses these projects/websites using his system username and system password. Should the first user decide to revoke access to these projects/websites, he does so at the site-wide sharing permission interface, as previously described.

In cases of permission revocation, the system is operable to ask the first user the motivation for the permission revocation. For example, the system can ask whether the revocation was motivated by a security breach, spam, obscene actions, etc. and/or asks the first user if a system-wide alert should be issued against the second user. In positively-confirmed cases, the system can send out a system-wide alert to the managing users of those subsets of projects and/or websites to which the second user has access permission.

Thus, the remote computing device runs a project manager operable to store, edit, display and share projects as project websites; access to the websites requiring the system username and password. The permission server runs a permissions manager; the permissions manager able to: allow a second remote computing device to access the corresponding websites of at least one subset of projects without allowing access to the other subsets of projects; deny the second remote computing device access to the corresponding websites of the at least one subset of projects without denying access to the other subsets of projects; and require a log-in with the system username and password of the second remote computing device to access the subset of corresponding websites. The permissions manager is also operable to allow the first remote computing device to revoke access to the corresponding websites of the at least one subset of projects with a single action.

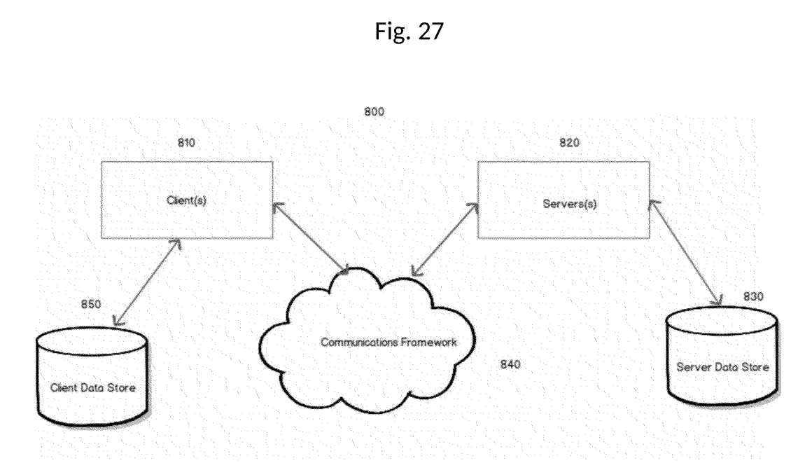

FIG. 27 is a schematic block diagram of a sample-computing environment 800 with which the claimed subject matter can interact. The system 800 includes one or more client(s) 810. The client(s) 810 can be hardware and/or software (e.g., threads, processes, computing devices). The system 800 also includes one or more server(s) 820. The server(s) 820 can be hardware and/or software (e.g., threads, processes, computing devices). The servers 820 can house threads to perform transformations by employing the subject innovation, for example. The servers are in communication with a data store 830, which may house the tags and taxonomy databases.

One possible communication between a client 810 and a server 820 can be in the form of a data packet adapted to be transmitted between two or more computer processes. The system 800 includes a communication framework 840 that can be employed to facilitate communications between the client(s) 810 and the server(s) 820. The client(s) 810 are operably connected to one or more client data store(s) 850 that can be employed to store information local to the client(s) 810. Similarly, the server(s) 820 are operably connected to one or more server data store(s) 830 that can be employed to store information local to the servers 820.

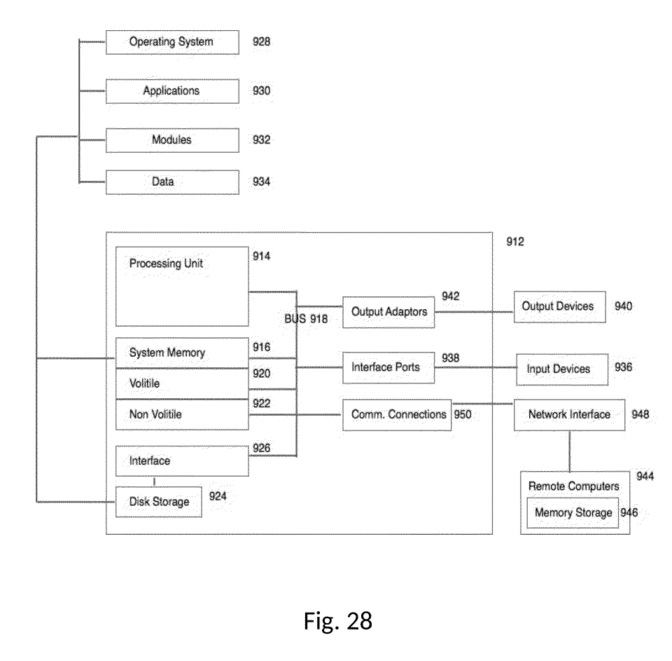

With reference to FIG. 28, an exemplary environment 900 for implementing various aspects of the claimed subject matter includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, industrial Standard Architecture (ISA), micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable programmable ROM (EEPROM), or flash memory. Volatile memory 920 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 912 also includes removable/non-removable, volatile/nonvolatile computer storage media. FIG. 28 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 28 describes software that acts as an intermediary between users and the basic computer resources described in the suitable operating environment 900. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that the claimed subject matter can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940, which require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system for sharing multimedia, comprising:
a cloud storage server;
a permissions server;
at least one remote computing device; and
a network;
the cloud storage server, the permissions server, and the at least one remote computing device being in electronic communication with the network;
the cloud storage server being configured to store at least one project, the project comprising at least one card deck, the card deck comprising at least one card, the at least one card containing card data, the card data comprising text, hypertext, and multimedia data;
the remote computing device including a project manager operable to store, edit, display and share one or more of the at least one project, the at least one card deck, and the card data;
the permission server running a permissions manager; the permissions manager being configured to:
allow the at least one remote computing device to access the at least one project, at least one deck or at least one card;
deny the at least one remote computing device access to the at least one project, at least one deck or at least one card on a site-wide basis; and
require a log-in through the remote computing device using a site username and password;
thereby providing a facile system for sharing multimedia.

2. A method performed by a System for sharing multimedia, the steps including:
storing text, hypertext and multimedia data as at least one card file;
storing at least one card file in a deck;
receiving edits to the at least one card file; and
managing permissions, using a permissions server, to the at least one card file, to the deck, or to the project;
wherein the step of managing permissions includes:
allowing access to media to a receiving user,
denying access to media to a receiving user on a site-wide basis with a single action, and
requiring a receiving user to log in using the user's site username and site password;
thereby providing a facile system of sharing multimedia.

3. The method of claim 2, wherein the system uses semantic uniform resource locators to provide access to the project media.

4. The method of claim 2, wherein each card contains a title, a description, at least one image, at least one link, and at least one card deck type definition.

5. The method of claim 2, wherein each card encapsulates user comments so that these comments are transportable with the card across projects.

6. The method of claim 2, further including the step of moving from a first card to a second card by swiping the first card in the opposite direction of the second card.

7. The method of claim 2, further including the step of showing a first image in a card in full screen view in response to clicking multiple times on the card, and then showing a next card in the project in response to a swipe motion.

8. The method of claim 2, further including the step of moving from a first card to a second card by swiping vertically or diagonally.

10. The method of claim 2, further including the step of adding a user to a project by:
showing all users for all projects in order of recency, and
selecting a status for the user,
wherein the status is selected from a group consisting of editor and viewer,
thereby making sharing a single-click operation.

11. The method of claim 2, further including the step of transferring a card to a different deck by dragging and dropping the card from one deck to another in a web view.

12. The method of claim 2, further including the step of transferring a card to a different deck in mobile view by exporting the card to a destination deck.

13. The method of claim 2, further including the step of copying cards between decks in response to a graphical copy and paste operation of a subject card from a source deck to at least one target deck.

14. The system of claim 1, wherein the project contains decks of different types.

15. The method of claim 2, wherein each deck is represented by an icon.

16. The method of claim 15, further including steps for re-ordering or deleting decks, the steps selected from a group consisting essentially of:
dragging and dropping an icon;
selecting, holding and deleting an icon; and
dragging an icon to a recycle bin;
thereby re-ordering or deleting the decks.

17. A system for managing websites, comprising:
a cloud storage server having stored thereon a multiplicity of projects, the projects each comprising at least one card deck, each card deck comprising at least one card;
a permissions server;
at least one remote computing device; and
a network;
the cloud storage server, the permissions server, and the remote computing device being in electronic communication through the network;
access to the system requiring a system username and password;
the at least one card containing text, hypertext, viewer comments and multimedia data;
the system organizing the multiplicity of projects into subsets,
the remote computing device running a project manager configured to store, edit, display and share the multiplicity of projects as a multiplicity of project websites, the multiplicity of websites being secured with the system username and password;
the permission server running a permissions manager; the permissions manager being configured to:
allow the remote computing device to access the corresponding websites of at least one subset of projects without allowing access to the other subsets of projects;
deny the at least one remote computing device access to the corresponding websites of the at least one subset of projects without denying access to the other subsets of projects; and
require a log-in with the system username and password to access a subset of corresponding websites;
revoking access to the corresponding websites of the at least one subset of projects with a single action;
thereby providing a system of sharing multimedia that is easy to use.

18. The system of claim 17, wherein a subset of projects comprises projects shared by a first user with a second user.

19. The system of claim 18, wherein the system sends out a system-wide alert upon receiving the revocation of access for the second user to the subset of projects.

20. The system of claim 19, wherein the system-wide alert goes to users sharing other subsets of projects with the second user.
